(19) United States
(12) Patent Application Publication
(10) Pub. No.: US 2005/0091082 A1
(43) Pub. Date: Apr. 28, 2005

(54) System and method for managing accounts receivable collections

(76) Inventors: Joe Garber, Las Vegas, NV (US); Jeff Newburn, Las Vegas, NV (US); Todd Wentworth, Boreman, MT (US); Vince Swertfager, Henderson, NV (US)

Correspondence Address: JENKENS & GILCHRIST, PC, 1445 ROSS AVENUE, SUITE 3200, DALLAS, TX, 75202, US

(21) Appl. No.: 10/875,816

(22) Filed: Jun. 24, 2004

Related U.S. Application Data
(60) Provisional application No. 60/514,318, filed on Oct. 24, 2003.

(51) Int. Cl. G06F 17/60

(52) U.S. Cl. 705/2

(57) ABSTRACT

The present invention describes a system and method for managing account receivable collections wherein patient records are downloaded from a hospital's collections management system in a PC based environment. Accounts Receivable collections associated with the downloaded patient records are managed using the collections management system in the PC based environment.

### RELATED APPLICATION(S)

This application claims priority from and incorporates herein by reference the entire disclosure of U.S. Provisional Application Ser. No. 60/514,318 filed Oct. 24, 2003.

### TECHNICAL FIELD

The present invention relates to accounts receivable for the health care industry, and more particularly, to a system and method for managing the collection of accounts receivable in the healthcare industry.

### BACKGROUND OF THE INVENTION

In the past, the collection of accounts receivable by hospitals has been an activity that has been handled solely by the hospital. The hospitals had in-house people responsible for attempting to collect past due accounts. These people were employees of the hospital and the system for assisting these individuals in collecting past due accounts were integrated into the software and operating system of the hospital. Companies for outsourcing the accounts receivable collections for hospitals have now come into being. In most cases, these companies relied upon modified versions of the hospital account tracking software to assist them in collecting the outsourced accounts receivable. While this jury-rigged system enabled the businesses to somewhat manage the outsourced accounts receivable collections, the systems were not optimally designed for the businesses and provided many difficulties. Also, many of these systems were server based requiring the data and software to be remotely accessed by the business managing the outsourced accounts receivable collections. This put control and operation of the data outside of the control of the business. Loss of server access could completely stop the operation of the business if the connection between the business and the servers containing the necessary data were down. Thus, there is a need for a system more directly focused on businesses responsible for collecting outsourced overdue accounts to enable them to easily interact with data provided from healthcare entities.

### SUMMARY OF THE INVENTION

The present invention overcomes the foregoing and other problems with a system and method for managing accounts receivable collections. The system includes a server enabling the downloading of patient records from a hospital to a collection management system in a PC based operating environment. The collection management system uses a plurality of computers associated with the server to manage accounts receivable collections of the downloaded patient records.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1a illustrates a prior art embodiment of a system for managing accounts receivable collection;

FIG. 1b illustrates the present invention for managing accounts receivable collections;

FIG. 2 is a functional block diagram illustrating the various interrelations of the screens and functionalities in the account collection management system;

FIG. 3 illustrates the Workstations List Screen;

FIG. 4 illustrates the Collection Worklist Screen;

FIG. 5 illustrates the Patient Worklist Screen;

FIG. 6 illustrates the Accounts Detail Screen;

FIG. 7 illustrates the Accounts Patient Screen;

FIG. 8 illustrates the Patient Editing Screen;

FIG. 9 illustrates the Guarantor Information Screen;

FIG. 10 illustrates the Guarantor Edit Screen;

FIG. 11 illustrates the Account Employer Screen;

FIGS. 12a-12b illustrate the Patient Employer Editing Screen;

FIG. 13 illustrates the Guarantor Employer Information Screen;

FIG. 14 illustrates the Insurance Overview Screen;

FIG. 15 illustrates the Insurance Information Screen;

FIG. 16 illustrates the Insurance Information Edit Screen;

FIG. 17 illustrates the Accounts Payment Plan Screen;

FIG. 18 illustrates the Accounts Cash Posting Screen;

FIG. 19 illustrates the Accounts Comments Screen;

FIG. 20 illustrates the Administration Main Menu;

FIG. 21 illustrates the View Staged Batch Screen

FIG. 22 illustrates the View Duplicate Staged Batch Screen;

FIG. 23 illustrates the Batch Status Screen;

FIG. 24 illustrates the Administration Station Screen;

FIG. 25 illustrates the Administration Rules Screen;

FIG. 26 illustrates the Administration Bad Debt Screen;

FIG. 27 illustrates the Administration Returned Mail Screen;

FIG. 28 illustrates the Administration Report Screen

FIG. 29 illustrates the Administration User Listing Screen;

FIGS. 30a-30c illustrate the Administrative Access Groups Screens; and

FIG. 31 illustrates the Administration System Activity Screen.

### DETAILED DESCRIPTION

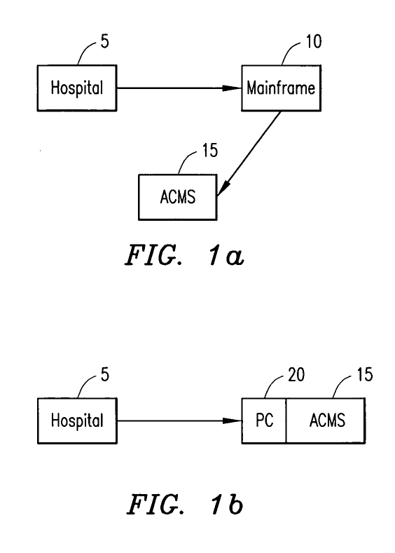

Referring now to the drawings, and more particularly, to FIGS. 1a and 1b, there are illustrated examples of a prior art embodiment and the present invention. FIG. 1a illustrates a prior art embodiment for managing overdue accounts. A hospital 5 may download its overdue account records to a mainframe based system where all the data records are stored. The data records for the overdue accounts are accessed by an account collection management system (ACMS) 15 that is located remotely from the mainframe based system 10. The present invention eliminates the use of a mainframe based system by directly downloading the overdue account records from a hospital 5 to a PC based system 20 located substantially concurrently with the account collection management system 15. This enables all data records in the account collection management system 15 to be substantially centrally located providing for easier processing and management of the data records by an outsourced business supplier.

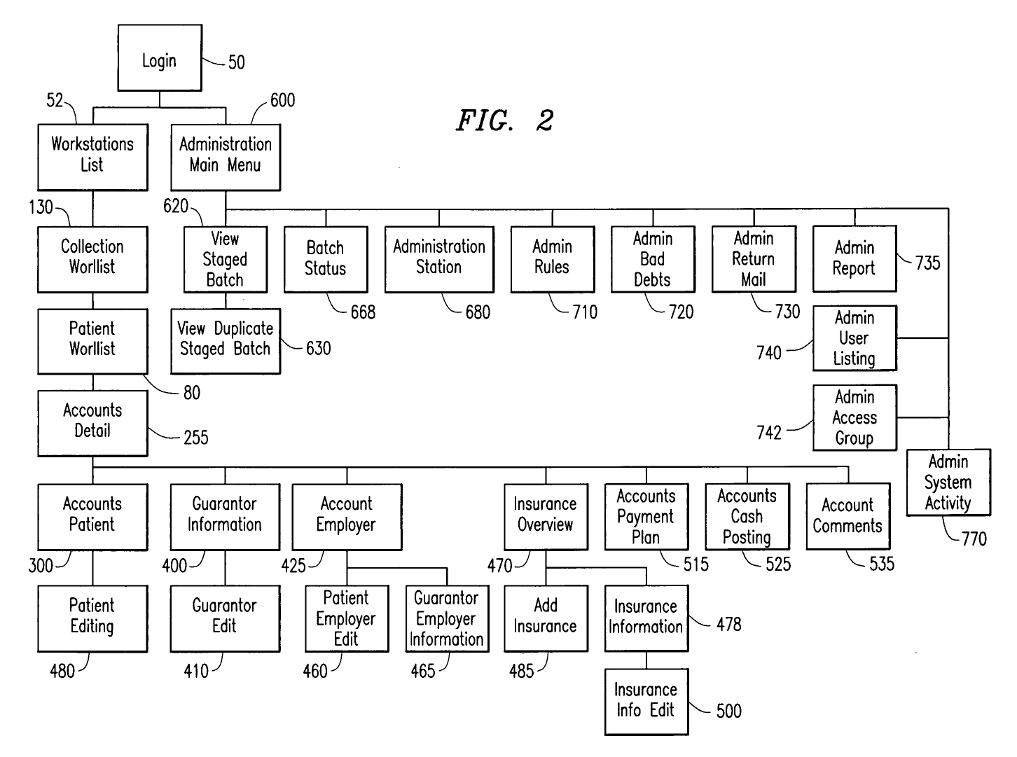

Referring now to FIG. 2, there are illustrated the various functionalities available to the user by the ACMS 15 of the present invention. The Login Screen 50 provides a user the ability to login to the ACMS 15. The Login Screen 50 appears automatically upon launching of the ACMS 15. The ACMS 15 requires a user to enter a user name and password into appropriate fields of the Login Screen 50 and click an associated login button in a known manner. If an incorrect password is entered, the Login Screen 50 is again presented to the user and the user is prompted to enter the user name and password again. If the incorrect password is entered three consecutive times, the account will be locked out of the ACMS 15.

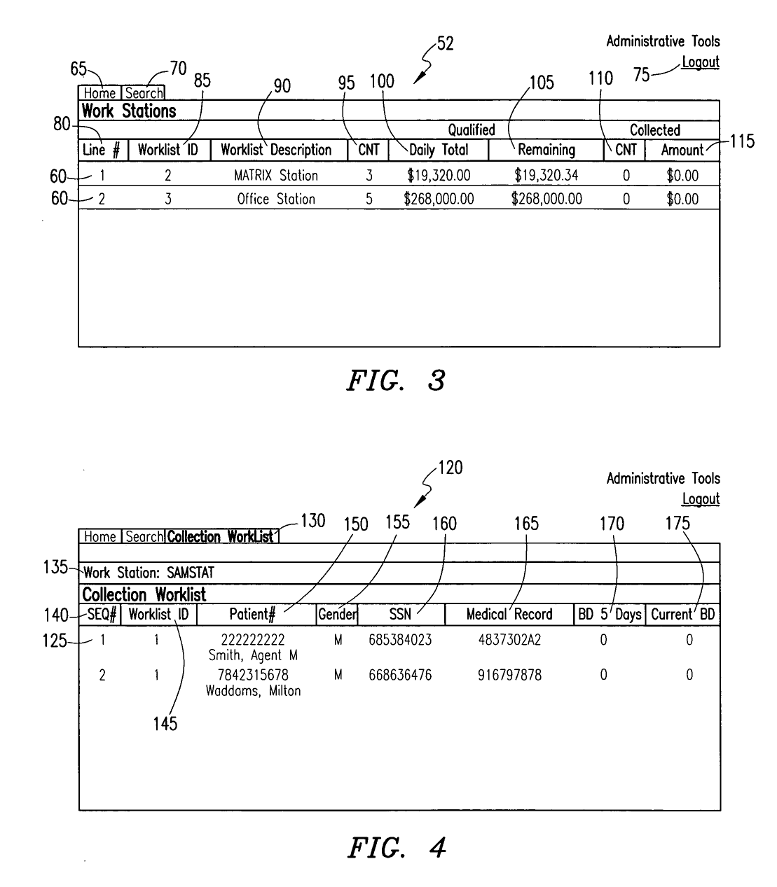

Once a user has successfully logged in, the user is presented with the Workstations List Screen 52 as shown in FIG. 3. The lower portion 55 of the Workstations Lists Screen 52 provides a list of available worklists 60. The worklist 60 describes the accounts that can be worked on by a particular user. The worklists 60 are user specific and may only be accessed by the user assigned to this worklist 60. Each row of the worklist comprises a single worklist that may contain a number of claims. The worklist information is accessed by clicking on the row of the worklist 60. The Workstations List Screen 52 also includes a home button 65 enabling immediate return to the Workstations List 52 and a search button 70 enabling the user to search through all patient records within the system. The Logout button 75 enables the user to log out of the system and return to the Login Screen 50.

A Line number 80 identifies the number of lines in the table containing the worklist. The Worklist ID 85 number provides the ID number that has been assigned to a particular worklist. The Worklist Description 90 identifies the name which has been assigned to the worklist. The CNT 95 describes the total number of remaining accounts within the worklist. The Daily Total 100 and Remaining Columns 105 identify the overall daily balance left on a worklist and the current remaining balance of a worklist. The CNT 110 describes the total number of accounts collected from a worklist, and the Amount 115 identifies the amount collected from a particular worklist.

Once a particular worklist 60 is selected and clicked on on the Workstations List Screen 52 the Collection Worklist Screen 120 (FIG. 4) is opened. The Collection Worklist Screen 120 contains a list of accounts in a worklist 60 for collection. The Collection Worklist Screen 120 also contains a Collection Worklist button 130 referencing the screen which is presently being viewed by the user. By pressing the Collection Worklist button 130 the data associated with presently viewed Collection Worklist will be refreshed. If the Collection Worklist button 130 is pressed while in another screen, the user will be taken back to the Collection Worklist Screen 120. Additionally, the presently accessed workstation 135 is displayed.

The number of accounts displayed within the Collection Worklist Screen 120 may be different from the number displayed in the CNT column of the Workstations List Screen 52. This is because multiple claims for a single patient will be grouped together in the Collection Worklist Screen 120. The Collection Worklist Screen 120 includes various information on particular patient accounts. The SEQ No. column 140 describes the number of the line in the table containing the patient information. The Worklist ID column 145 provides the worklist ID number of the patient. The Patient No. column 150 provides the patient ID number and name. The Gender column 155 provides the gender of the patient. The SSN column 160 provides the patient's social security number. The Medical Record column 165 provides the hospital's medical record number for the patient. The BD 5 Days column 170 describes the number of claims for the patient that are 5 days bad debt. The Current BD column 175 describes the number of claims under the patient's account that are bad debt.

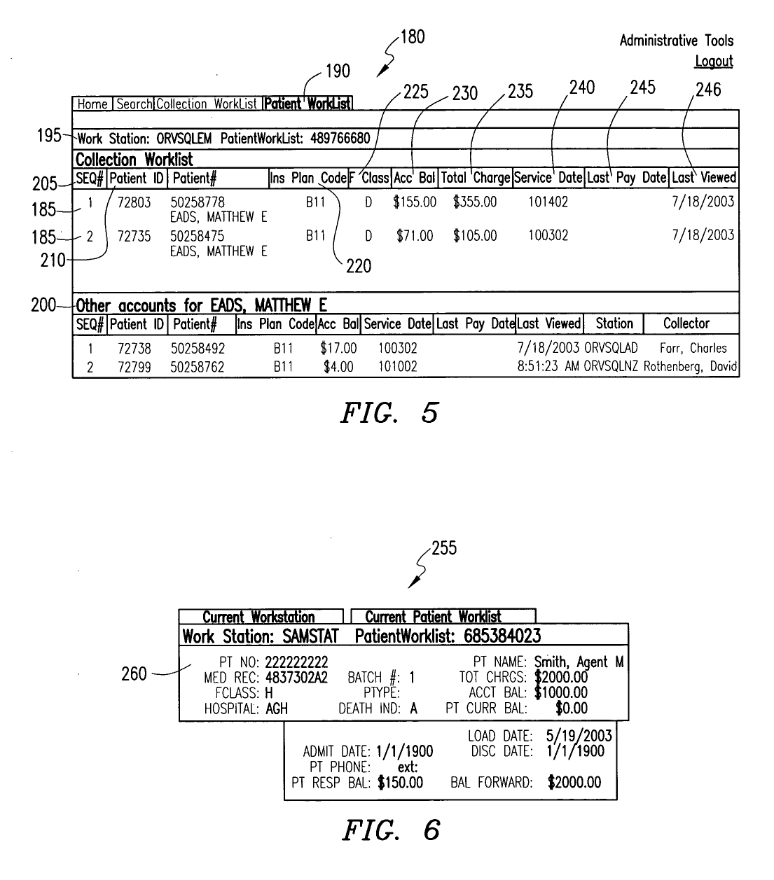

Once a particular patient line 125 is selected from the collection worklist, the Patient Worklist Screen 180 (FIG. 5) is displayed. The Patient Worklist Screen 180 displays all accounts for the patient in the current workstation. Each row 185 represents a current account for the selected patient. In one embodiment, the screen may apply each account in different colors depending upon the situation of the particular account. The top of the screen also includes a Patient Worklist button 190 enabling the user to quickly return to the Patient Worklist Screen 180 when on another screen, or when on the Patient Worklist Screen 180 to refresh the data displayed. Additionally, the Patient Worklist Screen 180 provides an indication of the Patient Worklist 195 currently being accessed by the user.

The lower portion of the Patient Worklist Screen 180 includes a list of accounts 200 comprising other accounts for the current patient that do not show up on the current worklist. These additional accounts may be in a first color indicating that the account 180 is not on the current worklist but is assigned to the particular user or a second color indicating that the account appears in a worklist not assigned to the current user. The Patient Worklist 180 and includes a SEQ No. column 205 indicating the number of the line in the table for the patient. A Patient ID number column 210, providing the patient's ID number and name, an Insurance Plan Code column 220 indicating the insurance plan covering the patient. An F Class column 225 indicating the financial class which is the grouping of the patients current working insurance. The Acc Bal column 230 provides the current monies due under the account. The Total Charge column 235 indicates the total amount charged for the services rendered to the patient. The Service Date column 240 indicates the date on which the services were rendered. The Last Pay Date column 245 indicates the date of the patient's last payment, and the Last Viewed column 246 indicates the last time that the particular patient account was viewed.

The color coding of the Patient Worklist may be such that a first color code is associated with an indication that cash has been posted to the patient's account today. A second color may be associated with an indication that an account will comprise bad debt within 5 days, and a third color may be associated with an indication that the account presently comprises bad debt.

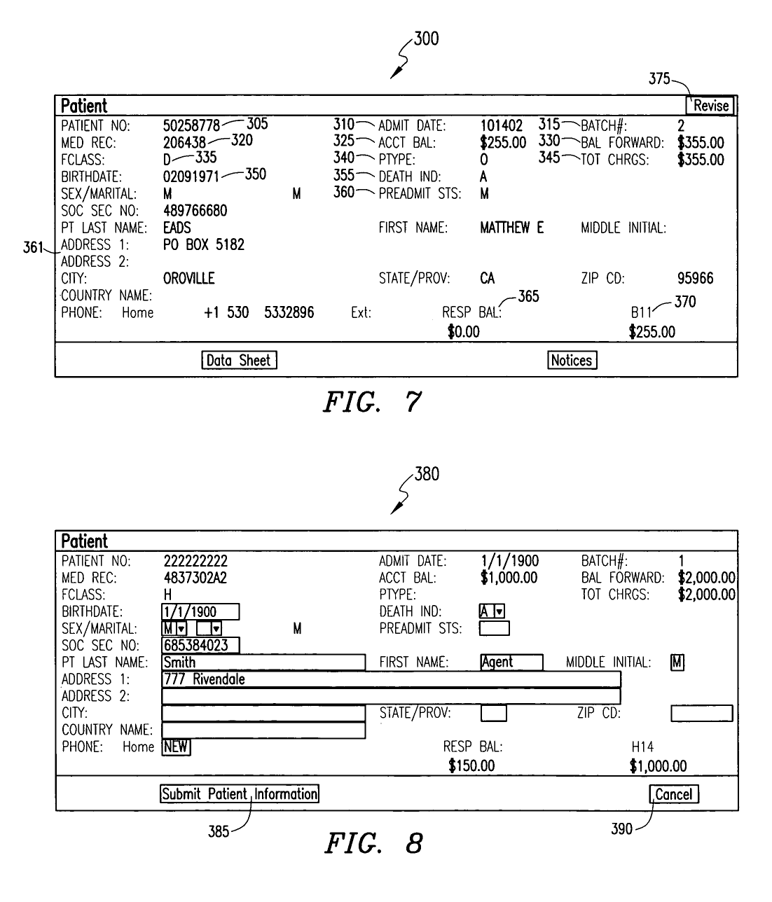

The Accounts Detail Screen 255 (FIG. 6) is brought up once a patient's account 185 has been selected. The Accounts Detail Screen 255 is divided into two areas. The header 260 includes important account information including Patient No., Medical Record No., F Class, Hospital, Batch No., PType, Death Indication, Patient Name, Total Charges, Account Balance, Patient Current Balance, Admit Date, Patient Phone No., Patient Responsible Balance, Load Date, Discharge Date and Balance Forward. The data from the current section of the Accounts Detail Screen 255 is displayed in the lower portion of the screen. From the Accounts Details Screen 255, the Accounts Patient Screen 300 (FIG. 7) may be accessed.

The Accounts Patients section 300 shows all basic patient information. This includes the Patient Account No. 305, Admit Date 310, Batch No. 315, the Patient's Medical Record 320, the Account Balance 325, the Balance Forward 330, F Class 335, P Type 340, Total Patient Charges 345, Patient Birthdate 350, Death Indication 355, Preadmit Status 360, Address 361, Responsible Balance 365 and B11 370. By clicking on the Revise button 375 within the Accounts Patient Screen 300, the Patient Editing Screen 380 (FIG. 8) is displayed. On the Patient Editing Screen 380, the user is able to enter or modify the patient's basic information. Changes to editable fields are made by clicking on the Submit Patient Information button 385 within the Patient Editing Screen 380. To cancel any changes made and return to the previous screen, the user clicks on the Cancel button 390.

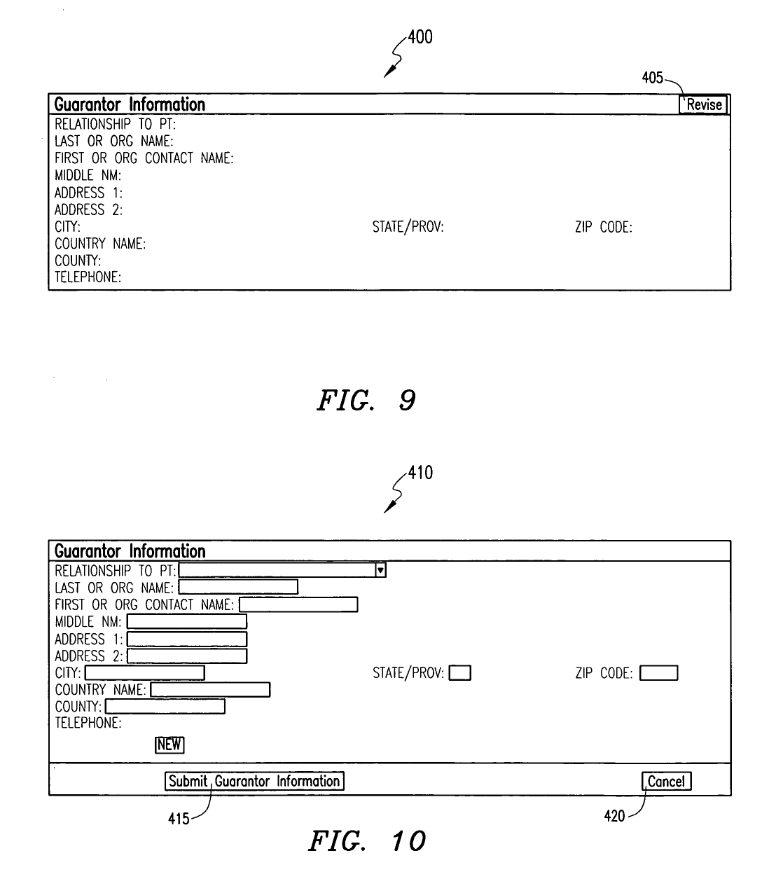

The Guarantor Information Screen 400 (FIG. 9) displays the patient's guarantor information. All information on this screen merely comprises a demographic of the patient. This information is edited by clicking on the Revise button 405 which brings up the Guarantor Edit Screen 410 (FIG. 10). The Guarantor Edit Screen 410 enables editing of the various information in the Guarantor Information Screen 400 in a manner similar to that done in the Patient Editing Screen 380. Information entered into the Guarantor Editing Screen 410 may be saved by clicking on the Submit Guarantor Information button 415 or may be canceled by clicking on the Cancel button 420.

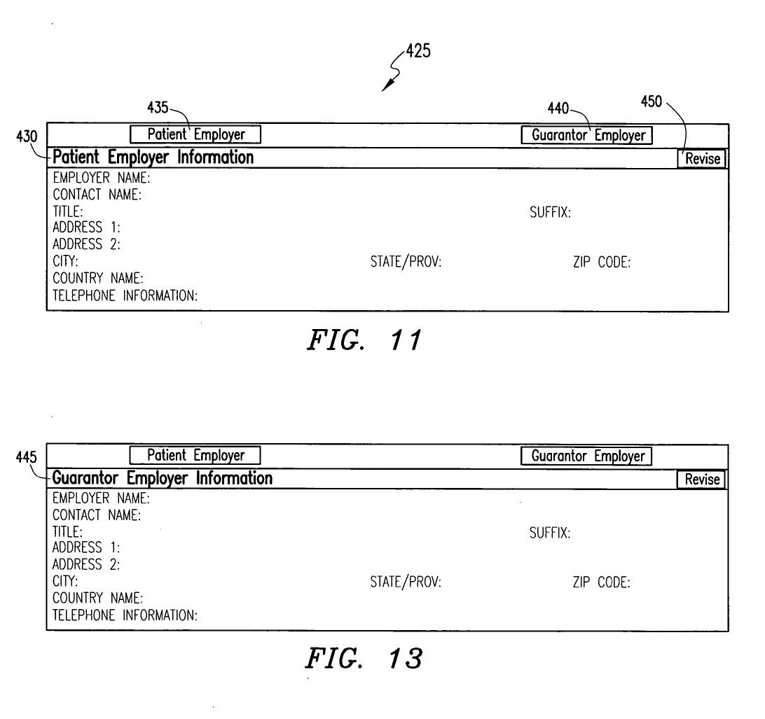

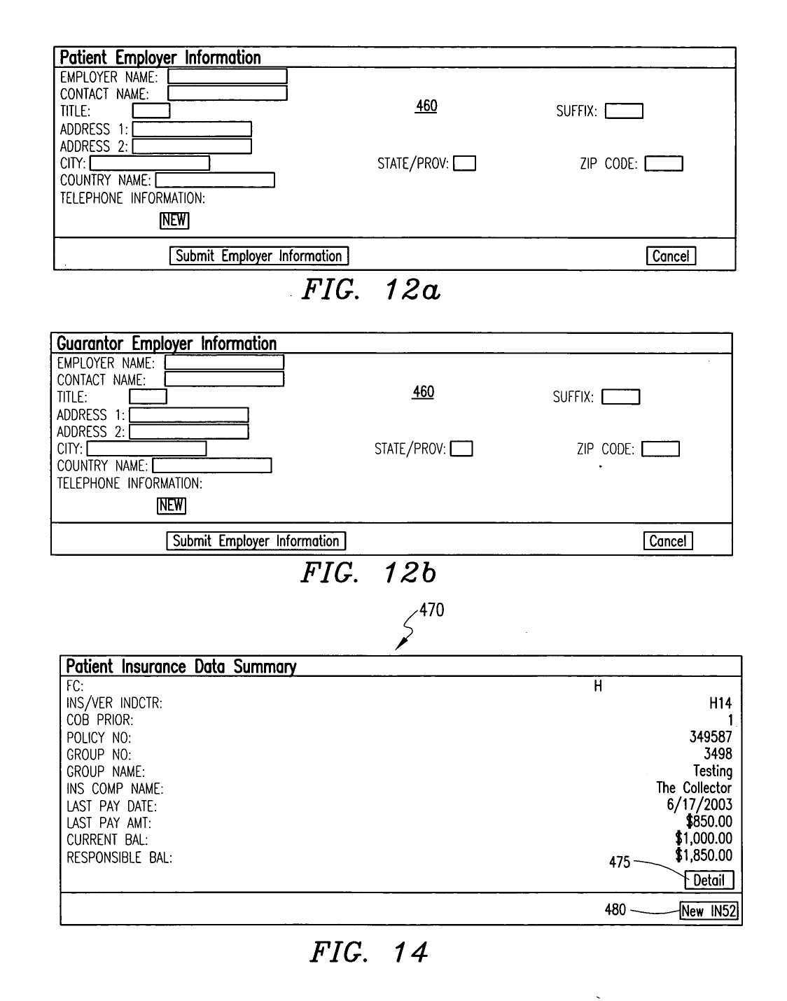

The Account Employer Screen 425 (FIG. 11) displays the patient's employer demographics as well as the demographics of the guarantor's employer. By default, the patient's employer information 430 is displayed. To switch between the patient and guarantor's information, the corresponding buttons 435 and 440 may be used to switch between the patient employer information 430 and the guarantor employer information 445 (FIG. 13). Any information on either screen may be edited by clicking the Revise button 450. Clicking on the Revise button 450 on each of the patient employer information 430 and guarantor employer information 445 provides the Patient/Guarantor Employer Editing Screens 460 (FIGS. 12a and 12b), respectively. These screens function in the same manner as the Patient Editing Screen 380 described previously.

The Insurance Screen 470 (FIG. 14) of the Accounts Screen display 255 provides the patient's insurance information. The Insurance Overview 470 is capable of handling numerous insurance carriers for each patient. If there are multiple insurance carriers for the current patient, they will each be listed in columns across the screen. If the insurance company has paid their responsible balance for the current account, the information will appear in a first color on screen. Additional information may be seen on the insurance carrier or adding or editing of any of the carrier information may be done by clicking on the Detail button 475. The New Ins No. button 480 pulls up the Add Insurance Screen.

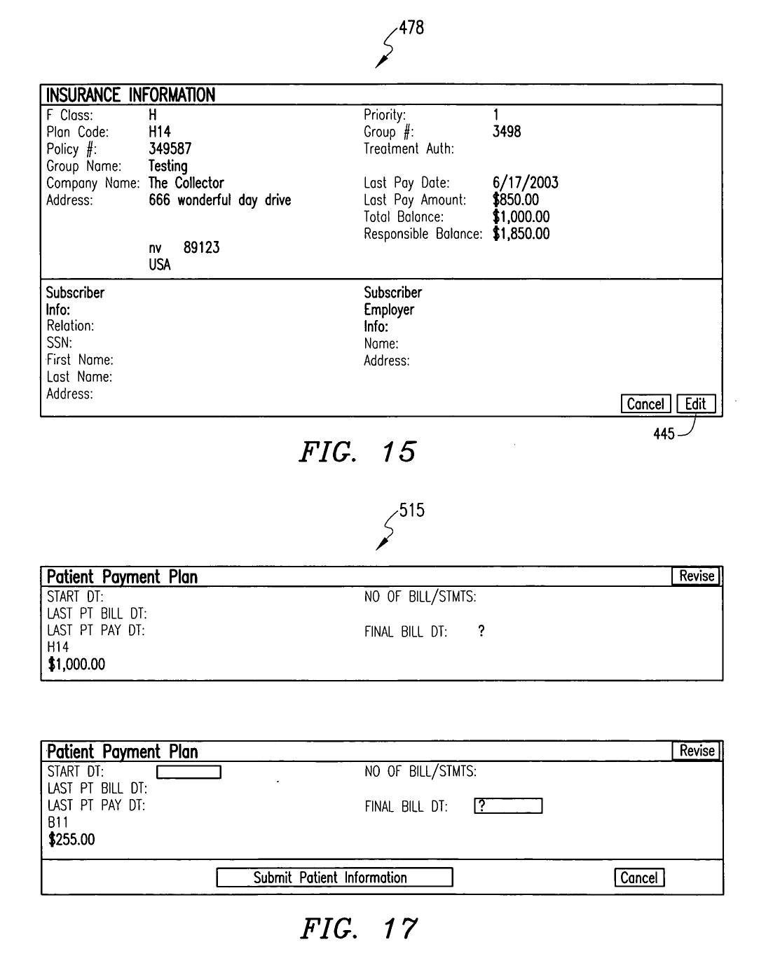

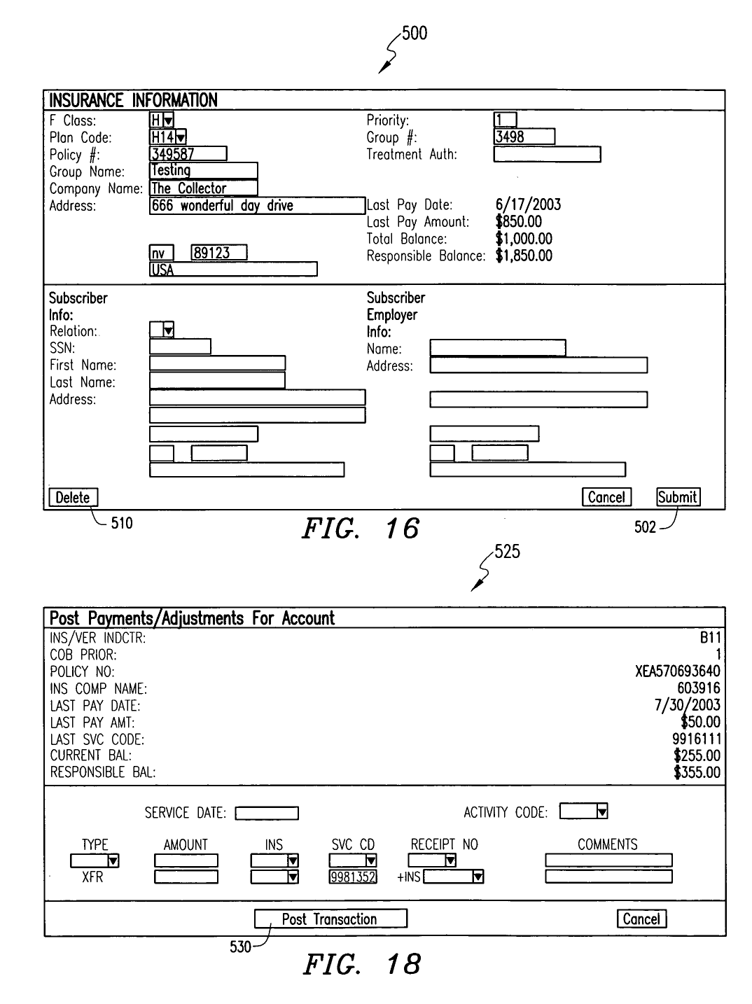

By clicking on the detail button 475 of the Insurance Overview Screen 470, the Insurance Information Screen 478 (FIG. 15) is opened. The Insurance Information Screen 478 displays a more detailed description of the insurance carrier. If any information on this screen needs to be modified, the Edit button 495 may be clicked to open an Editing Screen 500. The Insurance Information Edit Screen 500 (FIG. 16) provides for editing of information in the Insurance Information Screen 478. Changes may be entered by clicking on the Submit button 502. A particular carrier may be deleted by clicking on the Delete button 510.

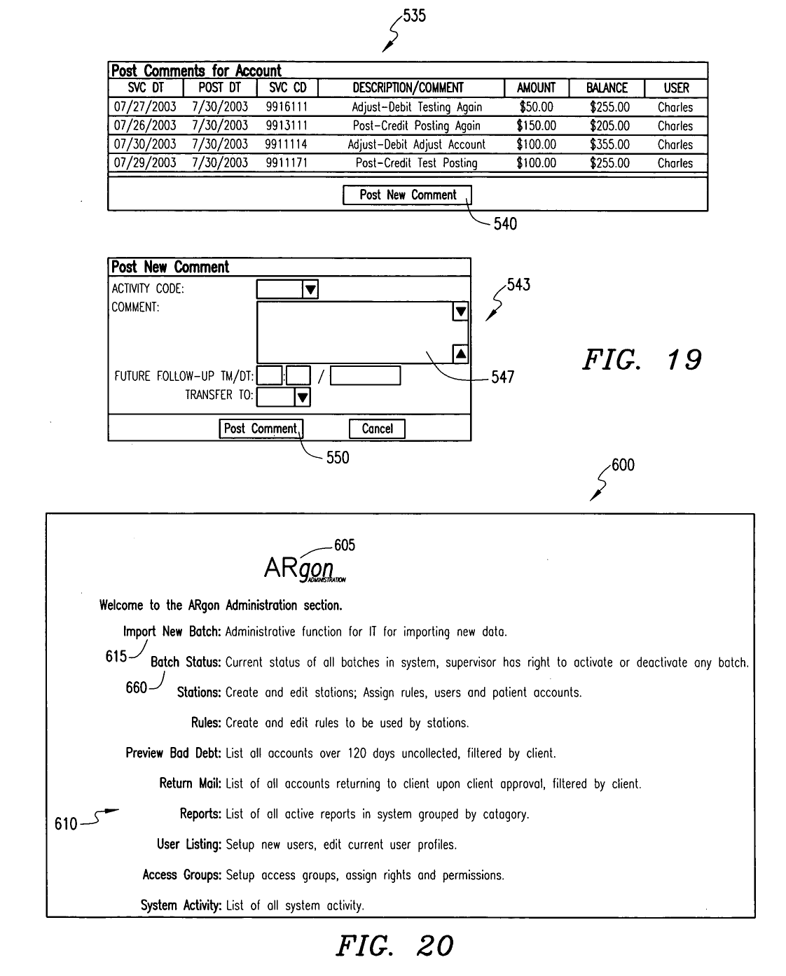

The Accounts Payment Plan Screens 515 (FIG. 17) provides for the ability to automatically establish a payment plan for patients owing money to the hospital. The Accounts Payment Plan Screen 515 includes the start date, the last payment bill date, the last payment payment date, the number of bills/statements and the final bill date. By clicking on the revise button 520, the start date and final payment dates may be revised. This screen also enables the generation of an automatic payment plan for a particular patient. The Account Cash Posting Screen 525 (FIG. 18) enables the posting of payments received from patients. This information is then reflected in the Patient Accounts Screen in substantially real time upon actuation of the Post Transaction button 530. The Accounts Comments Screen 535 (FIG. 19) provides for an entry of additional information concerning patient accounts. A New Comment window 543 is opened by pressing the Post New Comment button 540. The comment field 547 expands as necessary to allow entry of as much information as desired. The information is posted by pressing the Post Comment button 550.

Referring now to FIG. 20, there is illustrated the Administration Main Menu 600 and associated subscreens associated with the Administration portion of the system. The Administration Main Menu 600 has the same basic format as the rest of the application. The title bar 605 contains menus of sections for accessing various portions of the administrative menu and the lower portion 610 contains the contents of the selected section. Each of the items in the menu are actually explained on the screen in the lower portion 610 of the Administrative Main Menu 600.

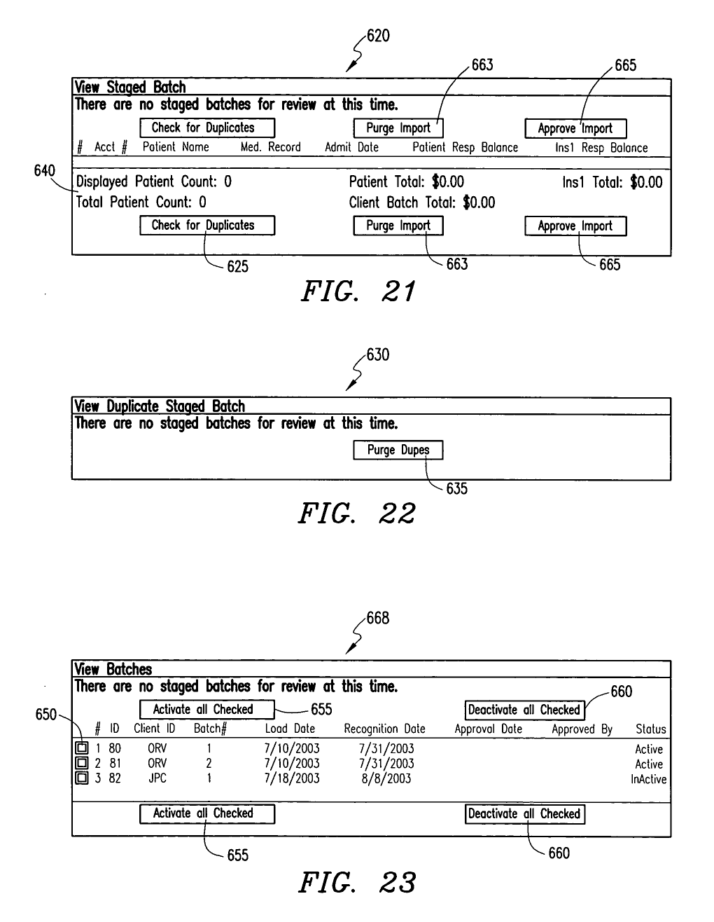

These include the Import New Batch, Batch Status, Stations, Rules, Preview Bad Debt, Return Mail, Report, User Listings, Access Groups and System Activity. The Import New Batch button 615 opens the View Staged Batch Screen 620 (FIG. 21). The View Staged Batch Screen 620 displays a list of the current accounts waiting to be loaded into the collections management system. The batches may be approved or declined from this screen. By pressing the Check for Duplicates button 625, the system determines whether or not duplicate accounts are included in the batch. This actuates the View Duplicate Staged Batch Screen 630 (FIG. 22). The View Duplicate Staged Batch 630 screen provides a listing of all duplicate accounts for an indication that no duplicate accounts are present. The duplicates may be purged by actuating the Purge Dupes button 635. The lower portion 640 of the View Staged Batch Screen 620 displays the Batch Totals. The Batch Totals are displayed as Displayed Patient Count, Total Patient Count, Patient Total, Client Batch Total and Ins Total. The Patient Total and Ins Total represent the amount owed by the client and insurance company. The Client Batch Total represents the combination of the Patient Total and the Ins Total. The Displayed Patient Count displays the total number of accounts listed on the screen, and the Total Patient Count displays the total number of accounts in the batch.

If problems arise with an import, the import may be deleted by clicking on the Purge Import button 663. Alternatively, if the batch appears to be ready, the Approve Import button 665 may be pressed to push the accounts into the collections management system. The Batch Status button 666 (FIG. 20) opens the View Batched Screen 668 (FIG. 23). The Batch Status Screen 668 enables the user to put batches in and out of the collections management system. If the status column 645 displays active, the accounts are available for use inside of the collections management system. If the status display column displays Inactive, the accounts are not available for use. Once a batch is imported, its status will be automatically set to inactive. To activate the batch, the user must check the box 650 next to the batch that needs to be activated and click the Activate All Checked button 655. A batch may be similarly activated by clicking the appropriate box 650 and clicking on the Deactivate All Checked button 660.

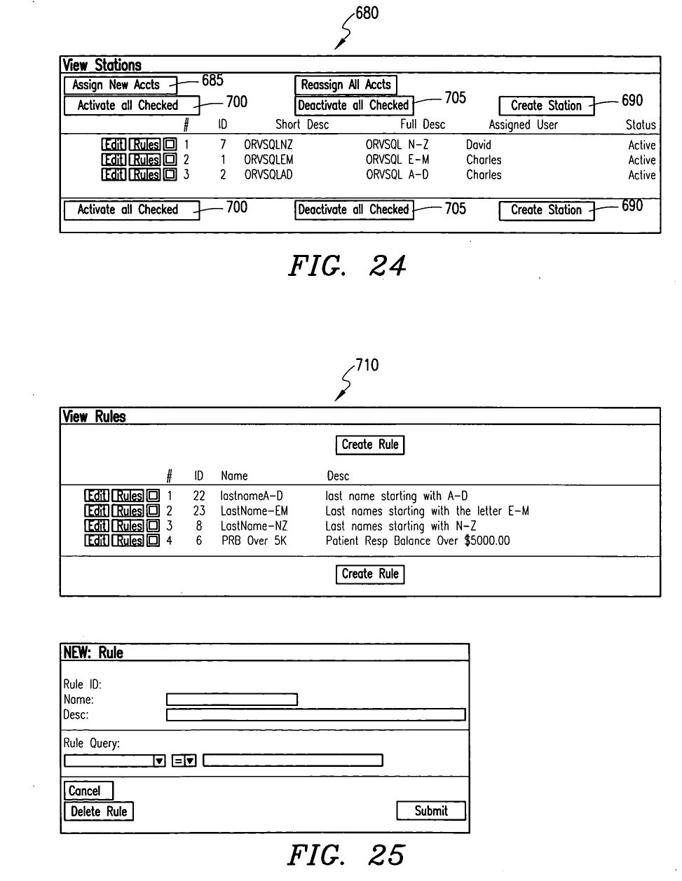

The Administration Stations Screen 680 (FIG. 24) enables the control of activities related to the various stations assign to various Worklists. Using the Assign New Accounts button 685, new accounts can be assigned to work stations. The Reassign All Accounts button 685 enables the reassignment of accounts. The Create Station button 690 enables the creation of new stations. Various stations may also be activated or deactivated using the Activate All Checked and Deactivate All Checked buttons 700 and 705.

The Administration Rules Screen 710 (FIG. 25) enables the creation of Rules for assigning patient accounts to various user stations. These Rules may be edited and changed by the system administrator in real time using the Administration Rules Screen 710. As can be seen in FIG. 25, multiple rules may be created for assigning patient records. These Rules may be edited and/or deleted by a system administrator, and can be temporarily enabled/disabled by check marking the Rules.

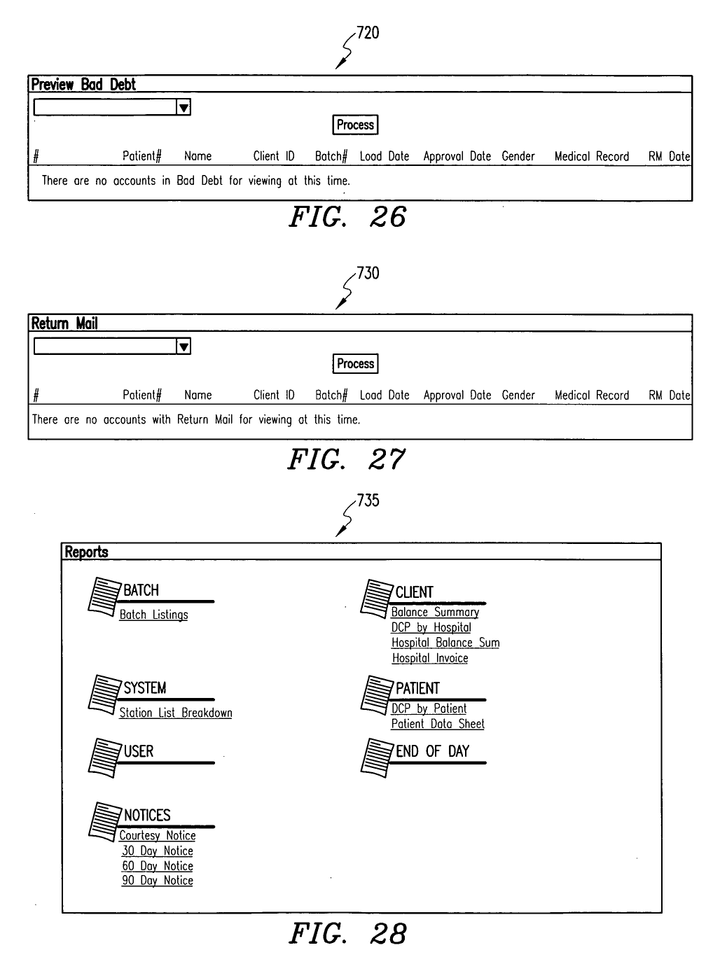

The Administration Bad Debts Screen 720 (FIG. 26) provides a listing of accounts comprising bad debts. The Administration Return Mail Screen 730 (FIG. 27) lists returned mail received from patients billings. The Administration Report Screen 735 (FIG. 28) provides a listing of a number of reports that may be provided by the system. Examples of reports include batch reports related to batch listings, system reports relating to station list breakdowns, user reports may be generated for individual users of the system, notices may be automatically generated by the system to patients having overdue Accounts Receivable in the form of courtesy notices, 30-day notices, 60-day notices and 90-day notices. Client reports for the hospitals will be generated illustrating the Balance Summary, DCP By Hospital, Hospital Balance Sums and Hospital Invoices. Patient Reports may be generated illustrating DCP By Patient and particular Patient Datasheets, and End of Day Reports may be generated describing work done for a particular day.

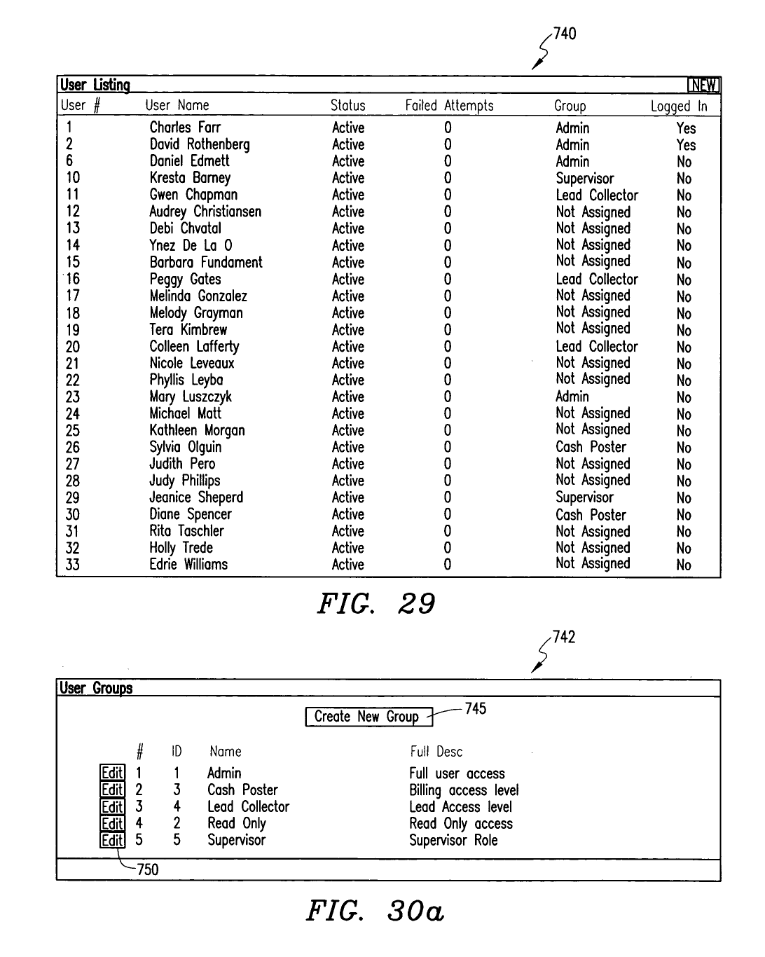

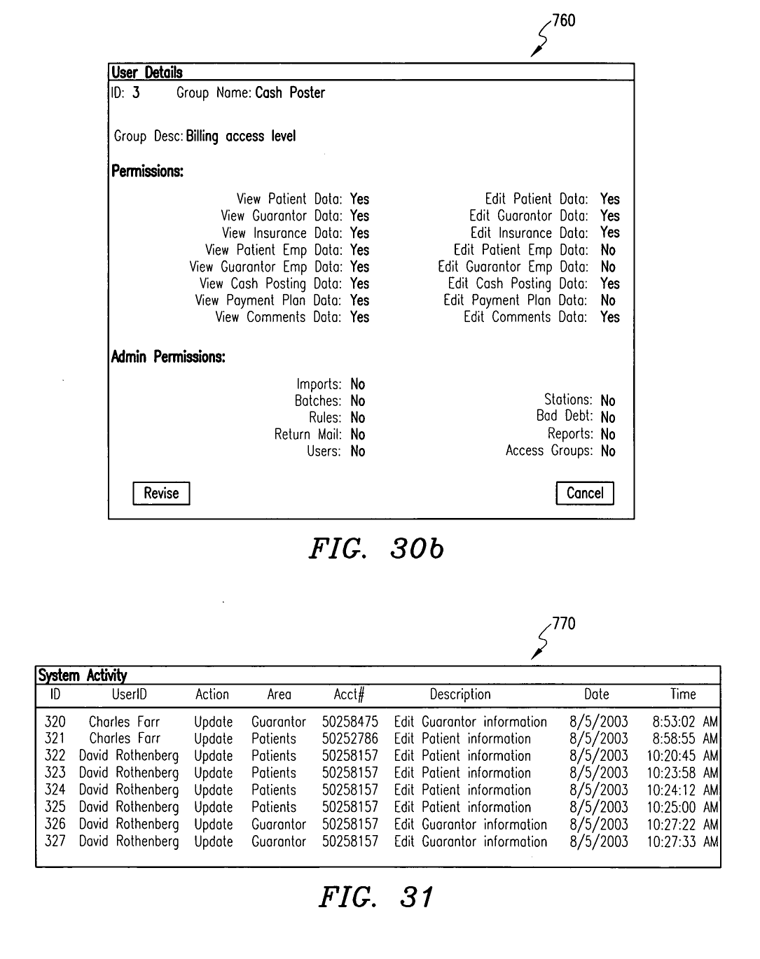

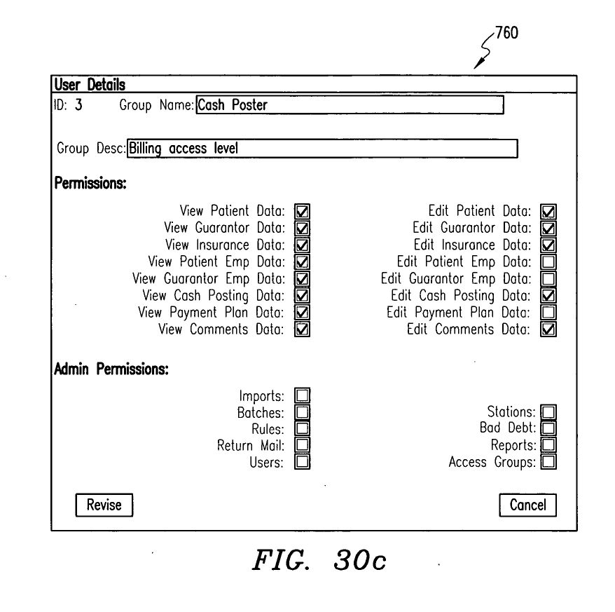

The Administration User Listing screen 740 (FIG. 29) provides lists of all users of the Account Collection Management System 15. The Administrative Access Groups Screen 742 (FIG. 30a) provides a listing of various groups and the type of access they have to the system. New groups may be created using the Create New Group button 745 or individual group accesses may be edited via the Edit buttons 750. By clicking the Edit button 750, the User Detail Screen 760 (FIG. 30b) is provided describing the access provided to a particular group. By clicking on the Revise button 760, check marks may be added or removed from the Permission and Administrator Permissions as desired (FIG. 30c). The Administration System Activity Screen 770 (FIG. 31) provides a listing of users and their particular activity within with the system.

The previous description is of a preferred embodiment for implementing the invention, and the scope of the invention should not necessarily be limited by this description. The scope of the present invention is instead defined by the following claims.

1. A method for managing accounts receivable collections comprising the steps of:
downloading patient records from a hospital to a collections management system in a PC based environment; and
managing accounts receivable collections of the downloaded patient records using the collections management system.

2. The method of claim 1, wherein the step of managing further comprises the steps of:
assigning a worklist to a plurality of users;
displaying an assigned worklist to at least one of the plurality of users; and
opening a selected patient record from the worklist responsive to selection of the patient record by the at least one user from the worklist.

3. The method of claim 1, wherein the step of managing further comprises the step of assigning the patient records to a worklist based upon an administrator controlled rules set.

4. The method of claim 3 further comprising the step of changing the rules set in real time.

5. The method of claim 3, the step of managing further comprises the step of assigning the patient records to worklists based upon multiple rules sets

6. The method of claim 1, wherein the step of managing further comprises the step of displaying a patient information in a header associated with the patient record.

7. The method of claim 1, wherein the step of managing further comprises the step of providing patients access to the collections management system via an Internet.

8. The method of claim 6, wherein the step of managing further comprises the step of enabling credit card payment to amounts due on the patient records.

9. The method of claim 1, wherein the step of managing further comprises the step of generating an automatic payment plan for amounts due on patient records.

10. The method of claim 1, wherein the step of managing further includes the step of posting payments to patient records in substantially real time.

11. The method of claim 1, wherein the step of managing further comprises expanding comment fields associated with patient records enabling inclusion of additional information.

12. The method of claim 1, wherein the step of managing further comprises the step of selectively enabling/disabling batches downloaded from the hospital.

13. An article of manufacture for managing accounts receivable collections, comprising:
processor readable storage medium; and
processor programming stored on said storage medium;
wherein said processor programming is configured to be readable from said processor readable storage medium by a processor and thereby causing said processor to operate so as to:
enable downloading patent records from a hospital to a collection management system in a PC based environment; and
manage accounts receivable collections of the downloaded patient records using the collection management system.

14. The article of manufacture of claim 13, wherein the processor programming is configured to further cause said processor to:
assign a worklist to a plurality of users;
display an assigned worklist to at least one of the plurality of users; and
open a selected patient record from the worklist responsive to selection of the patient record by the at least one user from the worklist.

15. The article of manufacture of claim 13, wherein the processor programming is configured to further cause said processor to assign the patient records to a worklist based upon an administrator controlled rules set.

16. The article of manufacture of claim 15, wherein the processor programming is configured to further cause said processor to change the rules set in real time.

17. The article of manufacture of claim 15, wherein the processor programming is configured to further cause said processor to assign the patient records to worklists based upon multiple rules sets.

18. The article of manufacture of claim 13, wherein the processor programming is configured to further cause said processor to display patient information in a header associated with the patient record.

19. The article of manufacture of claim 13, wherein the processor programming is configured to further cause said processor to provide patients access to the collection management system via an Internet.

20. The article of manufacture of claim 18, wherein the processor programming is configured to further cause said processor to enable credit card payment to amounts due on the patient records.

21. The article of manufacture of claim 13, wherein the processor programming is configured to further cause said processor to generating an automatic payment plan for amounts due on patient records.

22. The article of manufacture of claim 13, wherein the processor programming is configured to further cause said processor to posting payment to patient records in substantially real time.

23. The article of manufacture of claim 13, wherein the processor programming is configured to further cause said processor to expanding comment fields associated with patient records to enable inclusion of additional information.

24. The article of manufacture of claim 13, wherein the processor programming is configured to further cause said processor to selectively enable/disable batches downloaded from the hospital.

25. A system for managing collection of accounts receivable, said system comprising:
a server enabling downloading of patient records from a hospital;
a plurality of computers associated with said server, each of said computers configured to manage accounts receivable for downloaded patient records using a collections management system.

26. The system of claim 25, wherein the collection management system configures the computers to:
assign a worklist to a plurality of users;
display an assigned worklist to at least one of the plurality of users; and
open a selected patient record from the worklist responsive to selection of the patient record by the at least one user from the worklist.

27. The system of claim 25, wherein collection management system configures the computers to assign the patient records to a worklist based upon an administrator controlled rules set.

28. The system of claim 27 wherein the rules set is changed in real time.

29. The system of claim 25, wherein the collection management system configures the computers to assign the patient records to worklists based upon multiple rules sets.

30. The system of claim 25, wherein the collection management system configures the computers to display a patient information in a header associated with the patient record.

31. The system of claim 25, wherein collection management system configures the computers to provide patients access to the collections management system via an Internet.

32. The system of claim 25, wherein the collection management system configures the computers to enable credit card payment to amounts due on the patient records.

33. The system of claim 25, wherein the collection management system configures the computers to generate an automatic payment plan for amounts due on patient records.

34. The system of claim 25, wherein the collection management system configures the computers to post payments to patient records in substantially real time.

35. The system of claim 25, wherein collection management system configures the computers to expand comment fields associated with patient records.

36. The system of claim 25, wherein collection management system configures the computers to selective enable/disable batches downloaded from the hospital.
